(19) United States
(12) Patent Application Publication
(10) Pub. No.: US 2003/0098862 A1
(43) Pub. Date: May 29, 2003

(54) Method and system for building and using intelligent vector objects

(75) Inventors: W. Ben Hunt, Weston, CT (US); Erik Reinholm, Camarillo, CA (US); Alexander A. Schuessler, Greenwich, CT (US)

Correspondence Address: Lesley L Coulson Esq, 1006 N George Mason Drive, Arlington, VA, 22205, US

(73) Assignee: SmartEquip, Inc.

(21) Appl. No.: 09/985,902

(22) Filed: Nov. 6, 2001

(51) Int. Cl. G06T 1/00; G06F 17/00

(52) U.S. Cl. 345/418

(57) ABSTRACT

The method and system of the current invention allows any type of drawing, whether raster or vector, to be transformed into an intelligent scalable vector graphics objects. An intelligent scalable vector graphics object is created for each part within a parts diagram. The intelligent scalable vector graphics objects can be viewed using a standard browser. The intelligent scalable vector graphics objects may contain interactivity intelligence and external link intelligence. The files created using the present method and system are extremely small, and can be used with applications on mobile devices.

### FIELD OF THE INVENTION

This invention relates to the field of computer software. More specifically, the invention relates to a method and system for creating and using vector graphic objects. More particularly, the present invention provides a method for converting a drawing stored in its native graphics format or some other format into scalable vector graphics format, whereby elements or pieces of the physical item(s) represented in the original drawing are separated into discrete intelligent vector objects.

Portions of the disclosure of this patent document contain material that is subject to copyright protection. The copyright owner has no objection to the facsimile reproduction by anyone of the patent document or the patent disclosure, as it appears in the Patent and Trademark Office file or records, but otherwise reserves all copyrights whatsoever.

### BACKGROUND

Computer Aided Design and Drafting (CAD)

CAD systems comprise hardware and software used in a variety of disciplines to create detailed drawings. CAD systems are used by architects, engineers, drafters, artists, and others to create precision drawings or technical illustrations. CAD systems are frequently utilized by engineers to design items for manufacture. In the manufacturing industry, many CAD systems enable engineers to build virtual products by entering scientific or technical data, and to manipulate the virtual products. For example, CAD users can view two and three dimensional models of a design from different angles and change design parameters.

CAD data is stored in a file format that captures the layout and architecture of the products drawn. To this end CAD file formats contain enough drawing information to enable CAD software to precisely render the design images, and also allow a variety of graphical manipulations such as zooming, rotating, and changing view angles. CAD software provides functions that utilize the data associated with the drawings (e.g. sorting and searching through attribute values) as well as image manipulation. More recent advances in CAD technology have enabled users to test their designs (e.g. machine parts, construction blueprints) in a computer-simulated environment before testing manufactured prototypes.

Although many industries have adopted CAD technology, an official CAD file format has not been developed. Instead, the file formats developed by different CAD software companies, such as AutoDesk, have become industry de facto formats. One of the most widely used CAD formats is the Data Interchange File Format (DXF) from AutoDesk, although many other formats are used. Because of the lack of an open industry standard, CAD files are typically not portable from one CAD system to another, although CAD systems typically do provide some conversion capabilities.

A drawing of a pressure washer frame assembly created using a CAD system is shown in FIG. 1. As FIG. 1 illustrates, CAD drawings convey a great deal of information. The drawing in FIG. 1 has a title block 110, a parts legend 120, notes 130 and mechanical drawings 140. In the example shown in FIG. 1, each part of the pressure washer is identified by a number, as shown by the circled numbers linked by a connecting line to each part. Each circled number indicates an entry in parts legend 120. The view shown in FIG. 1 is an “exploded view” of the pressure washer. An exploded parts diagram visually separates and uniquely identifies each part.

CAD systems were developed to be used in the design and manufacturing processes. However, the drawings created in CAD systems are frequently used for other purposes. For example, exploded parts diagrams are used in parts manuals, or Illustrated Parts Catalogs (IPCs). The identifying numbers used in a parts diagram are typically not used in the design phase when the original CAD drawings are created. They are added to the drawings before they are published in the IPCs.

Parts manuals are used extensively in most equipment-based markets, from construction and engineering to aerospace to oil/gas/mining. IPCs are necessary for most maintenance, repair and operations (MRO) work within an equipment-related field, as service technicians repair equipment through a hands-on, visual inspection of a specific product, and identify parts in need of replacement by referring to parts manuals. These manuals typically contain exploded parts diagrams and parts list for each component of a particular model of a product. Parts lists are typically tables containing the diagram number, name and manufacturer identification number for each separate part of a component.

Historically, these manuals have been published on paper and distributed to service organizations. With the advent of CAD systems, drawings created and stored in CAD systems have been used in the printing of published manuals. More recently, many manufacturers and equipment OEMs have implemented electronic IPCs. Electronic IPCs have typically duplicated the paper format IPCs (exploded parts diagram plus parts list, organized by component), and in their simplest incarnation are merely electronic books that add no new functions over paper IPCs. For example, an electronic IPC may be published as portable document format (PDF) files that contain images of the pages of the paper manuals.

FIG. 2 illustrates an exploded parts diagram of the frame component of the pressure washer of FIG. 1 as it is used in an electronic IPC. FIG. 3 illustrates a parts list for the pressure washer of FIG. 1 as it is used in an electronic IPC. The parts diagram and parts list of FIGS. 2 and 3 were created from the original CAD drawing and reformatted within a Portable Document Format (PDF) file for an electronic IPC.

Current electronic IPCs are difficult to use and limited in functionality. The biggest problem with current electronic IPCs is in the way they handle the graphical component of the parts catalog: the exploded parts diagram. Current electronic IPCs typically do not use drawings in their native CAD format. This would require any service organization using the IPC to have software capable of reading files in their native CAD format. As discussed above, there are many different CAD data formats, and most CAD files require expensive proprietary software to view and manipulate the drawings in the files. Also, since most equipment operators own products supplied by multiple manufacturers, they would require many different CAD graphics viewers in order to use electronic IPCs that publish the parts diagrams in their native CAD format, as each manufacturer may use a different CAD system.

As an alternative to native CAD formats, many current electronic IPCs convert the parts drawings to a raster or bitmap format. Raster or bitmap format files, such as GIF or TIFF, are easily viewable in many applications, including web browsers. However, raster images are large in file size, even when compressed. Raster image files therefore cannot be used with mobile devices. In addition, raster images become distorted when zoomed or magnified. Also, although some electronic IPCs include hotspots on the raster images to link to part and assembly information, there is no true intelligence in the raster parts diagram, just an overlay that contains hyperlinks

As an alternative to raster, some current electronic IPCs use vector graphics format files, such as CGM (computer graphics metafile) format files. A vector graphics format allows graphic objects to be represented as geometric shapes (e.g. lines, curves). Graphics described in vector format have a distinct advantage over raster images. The raster formats (GIF, PNG, JPEG and TIFF) are collections of pixels with no connecting information, and result in large files, even with advanced file compression techniques. Raster image formats must transmit all the space around a line as well as the line itself. Vector graphics formats, on the other hand, are mathematically derived representations of points in Cartesian space. Since only the mathematical representations (such as the equation describing a circle) need to be saved or transmitted, the file size or download time of a vector graphic format drawing is greatly reduced.

However, like the electronic IPCs that utilize raster drawings, there is no intelligence embedded in the vector files used in current electronic IPCs. Like raster images, it is possible to overlay hotspots on the vector graphics image that link to additional information, however, current electronic IPCs do not embed intelligence in the vector graphics files.

In addition, as with native CAD format files, CGM is not a standard format that can be universally recognized and viewed through most readily-available applications. Although it is relatively easy to convert drawings from almost any native CAD file format to CGM or DXF, software capable of viewing even these relatively more standard formats is expensive and is not well distributed. In addition, the viewing applications that are available are typically not easy to use and require training.

Therefore, there is a need for transforming drawings from native CAD formats, or other formats, to a “smart” format that can be viewed and graphically manipulated by many applications, including web browsers, and that can intelligently link to external information, and also results in small files that can be used on mobile devices. The present invention provides such a method and system.

### SUMMARY OF THE INVENTION

Accordingly, the present invention is directed to a method and system for creating intelligent real object vector representations for every part or entity in a drawing.

In accordance with one embodiment of the present invention, there is provided a method of representing a plurality of entities within a drawing as real object vector representations. The method includes obtaining a drawing; for each entity in the drawing, identifying at least one vector graphic within the drawing; creating a computer-storable object that is comprised of the identified at least one vector graphic; and attaching metadata to the computer-storable object.

In addition, in accordance with a further aspect of the present invention, there is provided a method of embedding intelligence in every part in a vector-based parts diagram. The method includes creating a template script; for each part, identifying at least one vector graphic in the parts diagram; for each part, customizing the template script using information specific to that part; and for each part, storing the customized script with computer code defining the part.

In addition, in accordance with a further aspect of the present invention, there is provided a method of viewing a parts diagram in a web browser, wherein every part in the parts diagram is stored as a separate object, and every part is linked to information stored in an external application that is specific to that part, such that a predefined event will cause information specific to that part to be displayed with the part in the web browser.

In addition, in accordance with a further aspect of the present invention, there is provided a method of viewing a parts diagram in an application on a mobile device, wherein every part in the parts diagram is stored as a separate object, and every part is linked to information stored in an external application that is specific to that part, such that a predefined event will cause information specific to that part to be displayed with the part in the application on the mobile device.

Additional features and advantages of the invention will be set forth in the description that follows, and in part will be apparent from the description, or may be learned by practice of the invention. The objectives and advantages of the invention will be realized and attained by the system particularly pointed out in the written description and claims hereof as well as the appended drawings.

### DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention.

In the drawings:

FIG. 1 shows a CAD generated drawing for a pressure washer.

FIG. 2 shows an exploded parts diagram used in an IPC for the pressure washer of FIG. 1.

FIG. 3 shows a parts list used in an IPC for the pressure washer of FIG. 1.

FIGS. 4A and 4B show a raster image in a standard view, and in a magnified view.

FIGS. 5A and 5B show a SVG image in a standard view, and in a magnified view.

FIG. 6 shows a high level flowchart illustrating the steps involved in creating a ROVR (Real Object Vector Representation).

FIGS. 7A and 7B show a user interface for selecting vector graphics that comprise a graphic element.

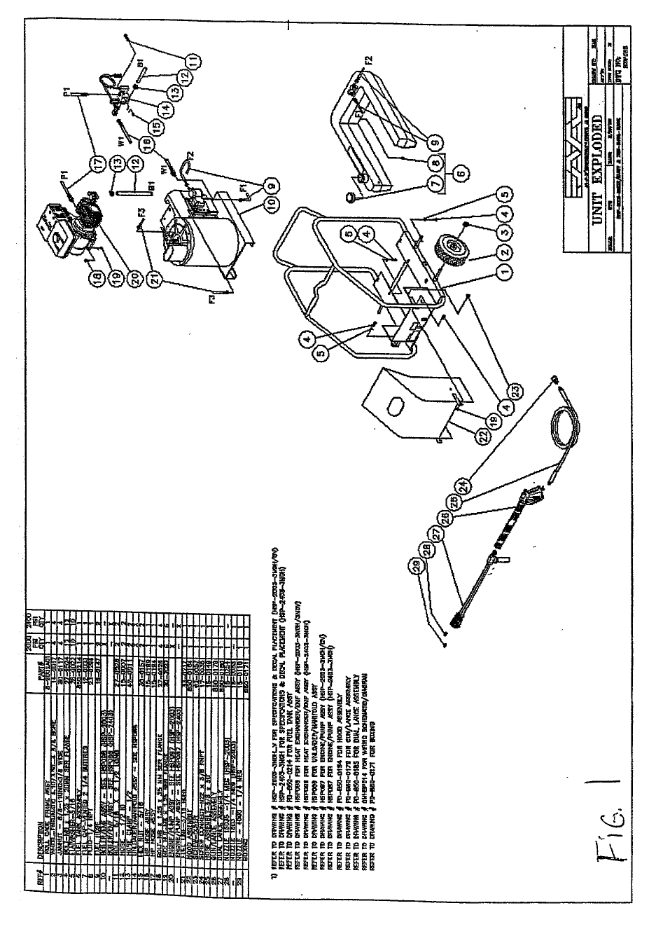

### DETAILED DESCRIPTION

In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

The present invention creates a discrete graphical object—a “Real Object Vector Representation” (ROVR)—for every element of a product or item represented in a drawing. That is, in the example of an exploded parts diagram for a manufactured item, a ROVR is created for every numbered element in the exploded parts diagram. By creating discrete graphical objects for each element, the present invention allows intelligence to be embedded with each graphical object. In the example of exploded parts diagrams used in IPCs, parts list intelligence is embedded with the ROVRs, thereby eliminating the need for a separate parts list in an electronic IPC that utilizes the ROVRs. In addition, the ROVRs provide direct links to external databases and applications, and provide interactive effects when viewed.

The present invention utilizes the power of Scalable Vector Graphics (SVG) format to build the real object vector representation system.

Scalable Vector Graphics (SVG)

SVG is a format for describing two-dimensional graphics in XML (extensible Markup Language). XML is a human-readable, machine-understandable, general syntax for describing hierarchical data. XML is based on the concept of documents composed of a series of entities. Each entity can contain one or more logical elements. Each of these elements can have certain attributes (properties) that describe the way in which it is to be processed. XML also provides a formal syntax for describing the relationships between the entities, elements and attributes that make up an XML document.

Like XML, SVG is a meta language format that provides descriptions of how data is structured, as well as how data should look. In the case of SVG, the data is mathematical representations of graphical objects. SVG includes elements for vector graphic shapes (i.e. paths consisting of straight lines and curves), images, animation and text.

Both XML and SVG are open standards developed under the auspices of the World Wide Web Consortium (W3C). Because XML and SVG are standard formats, the vast majority of software applications, such as web browsers, recognize these formats. In addition, because of the development of the XML and SVG standards, other previously proprietary formats similar to SVG, such as Macromedia's SWF format, have become open source formats. This means that almost all web browsers can view drawings stored in SVG or SWF format files. It will be obvious to one skilled in the art that SWF files could be used as an alternative to SVG files in the system of the present invention.

Unlike raster images, SVG graphics are described as a whole, instead of by individual pixels. This allows for easy control of the way graphics are coded. For example, a rectangle or a circle is coded using its mathematical representation or equation.

The following is an example of SVG code representing a circle:

| | |
|---|---|
| 1. | <!ENTITY % circleExt “” > |
| 2. | <!ELEMENT circle (%descTitleMetadata;, |

(animate|set|animateMotion|animateColor|animateTransform
%geExt;%circleExt;)*) >

| | |
|---|---|
| 3. | <!ATTLIST circle |
| 4. | %stdAttrs; |
| 5. | %testAttrs; |
| 6. | %langSpaceAttrs; |
| 7. | externalResourcesRequired %Boolean; #IMPLIED |
| 8. | class %ClassList; #IMPLIED |
| 9. | style %StyleSheet; #IMPLIED |
| 10. | %PresentationAttributes-Fillstroke; |
| 11. | %PresentationAttributes-Graphics; |
| 12. | transform %TransformList; #IMPLIED |
| 13. | %graphicsElementEvents; |
| 14. | cx %Coordinate; #IMPLIED |
| 15. | cy %Coordinate; #IMPLIED |
| 16. | r %Length; #REQUIRED > |

As shown, the SVG code comprises several types of data including the XML tags, the graphical object definition and the attributes.

XML tags indicate, for example, the beginning of the object and its type (e.g. line 1 and 2). Other tags indicate attribute types and their values (e.g. lines 3 through 16). For example, “cx” indicates the x-axis coordinate of the center of the circle; “cy” indicates the y-axis coordinate of the center of the circle; and “r” the radius of the circle.

The SVG format language fully conforms to XML, which allows use by standard XML tools such as validating parsers, editors, and most importantly, browsers. Because all XML-enabled browsers can render drawings stored in SVG, the SVG format is extremely portable.

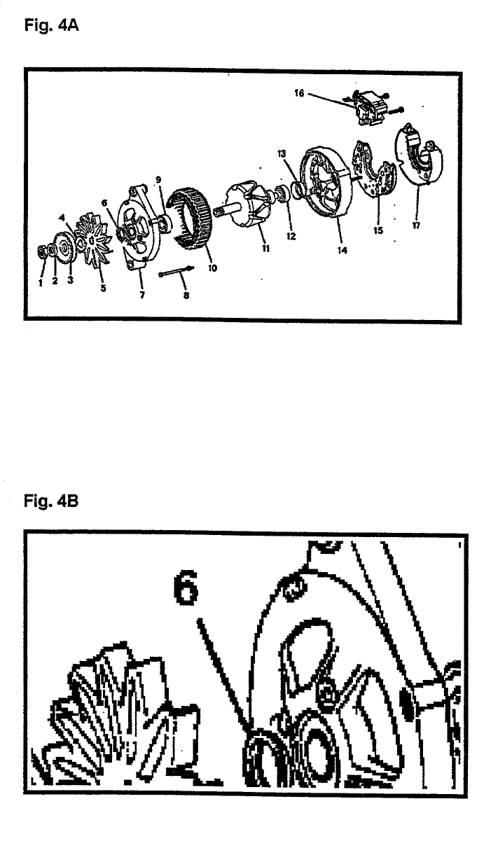

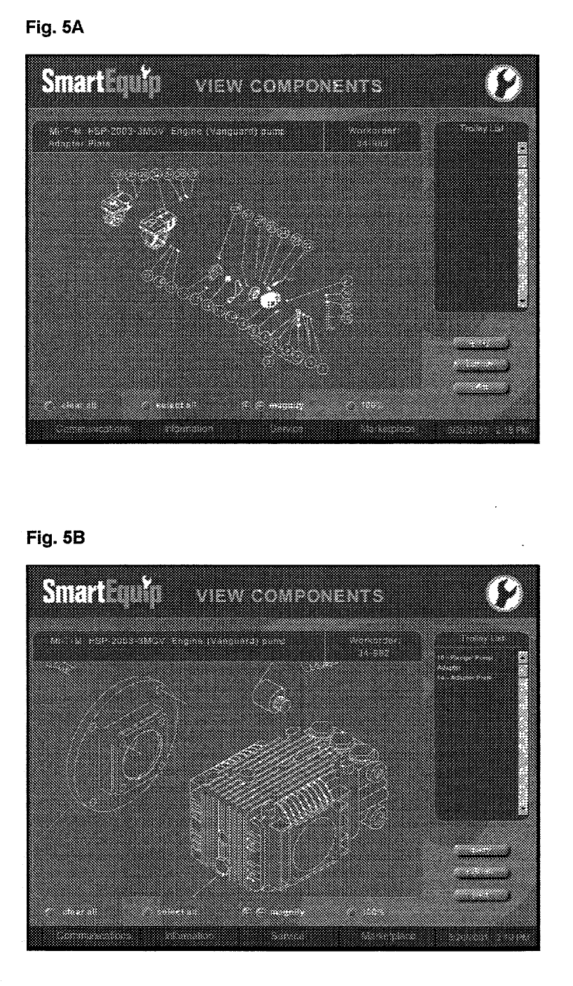

In addition, the scalability inherent to vector lines means that vectors are scalable on the client browser. Zooming in to look at detail in a vector format graphics image does not degrade in the same way that raster images degrade. When a raster image is magnified, the pixels simply appear larger. When magnified enough, the graphic takes on a fuzzy or jagged appearance. FIG. 4A illustrates an example TIFF image, and FIG. 4B illustrates the same raster image magnified. As shown, the magnification does not provide the user with a useful view. This type of image degradation occurs with all raster images. However, the vector equation of a line is the same from point to point whether viewed from afar or very close. FIG. 5A illustrates an image rendered using SVG, and FIG. 5B shows a magnification of the image. As shown, the magnification allows the user to obtain a useful close-up view of a component of the product.

One of the most important aspects of the SVG format is the incorporation of graphic linkages. For example, a “rollover” effect can be stored with a vector graphic, such as a line, polygon or symbol, that will cause the vector graphic to be highlighted when the cursor passes over the vector graphic in the viewing application. In addition, a graphic linkage associated with a vector graphic may link to a more detailed SVG drawing, additional data or external applications.

Since SVG is embedded in XML, it can coexist with XHTML tabular data and link to Xquery property records as well as additional SVG entities. The links can also tie into data servers. Anchor tags are part of the SVG language allowing normal URL links to be directly tied to graphic symbols of any complexity. The capability inherent with anchor tags is not limited to simple hyperlinks. Any kind of intelligence can be built into server side code and accessed graphically through the SVG entities.

In addition, vector graphics files are much smaller than raster graphics files, because vector graphics file require much less code to describe an object by mathematical equations than by dot-by-dot descriptions. For example, any graphical representation of a line can be described by the equation y=mx+b, or it can be described by a list of each screen pixel that should be activated. The difference in file size can be quite dramatic. For example, an exploded parts diagram saved in a TIFF file may require 1,000 kbytes. PDF files typically require even more space, ranging upwards of 3,000 kbytes for a single drawing. The same drawings stored in an SVG file typically requires less than 30 kbytes.

Even among vector graphics formats, there are significant differences in file size. A typical CAD parts diagram in DWG format typically ranges between 500 and 1,000 kbytes in size, which is significantly larger than a corresponding SVG file. In addition, the SVG file of the present invention may also be compressed, reducing the file size by an additional 30% or more using standard lossless compression techniques.

Because of the extremely small file size, drawings in the present invention can be transmitted wirelessly with almost no lag time. By using standard compression and streaming techniques, drawings stored in SVG format can be remotely accessed in near real-time. In the context of an electronic IPC, an entire library of parts manuals can be accessed remotely by service technicians. In addition, the present invention provides for client software that can operate on mobile device operating systems on such devices as handheld PCs and pocket PC devices.

Because of these features, SVG is ideally suited for use in electronic IPCs. However, it is not a simple task of converting one graphics file type to another. The present invention provides a method for performing the conversion such that the elements in the original drawing are saved as discrete objects. It is in these discrete objects that the inventive system embeds intelligence. In addition, although the invention is described using the example of electronic IPCs, it will be obvious to those skilled in the art that the process and system described herein can be used in many different applications and is not limited to the equipment service industry.

Real Object Vector Representation (ROVR) System

In the electronic IPC example discussed above, manufacturers publish parts manuals containing exploded drawings of each product for which they sell parts. A product is referred to as a “model”, which is a specific type of equipment within a general product category. For example, within the product category of pressure washers, a manufacturer may sell four different types or product models of pressure washer. Each separate product model will typically be described by a separate parts manual.

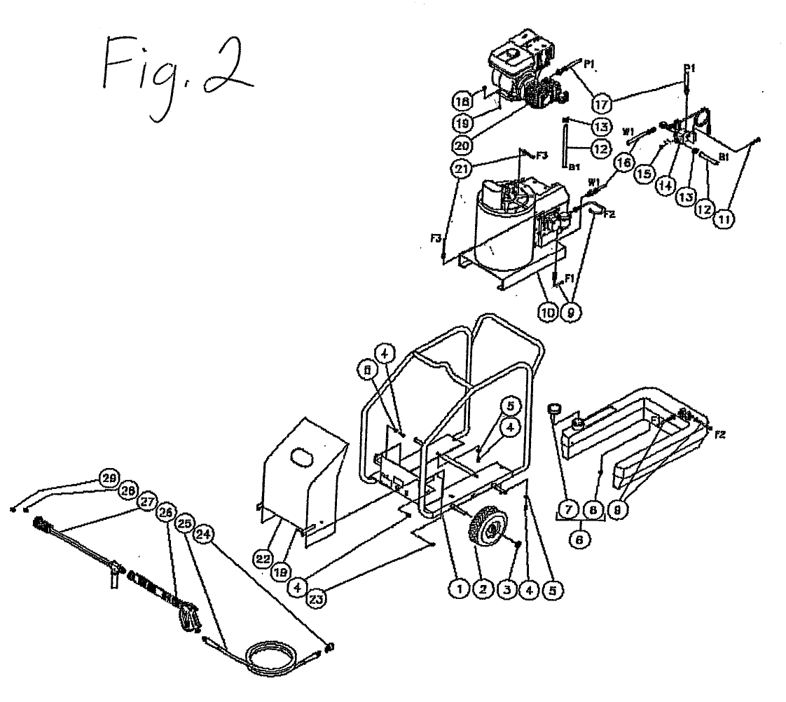

Each product model is typically comprised of several “components”, which are the structural assemblies of a whole piece of equipment. Each component of a model typically has its own parts diagram in the manual. For example, a pressure washer may be comprised of an engine, a frame and a hose assembly. Each of these components will typically have a separate parts diagram within the manual. FIG. 2, for example, is a diagram of the frame component of a specific model of pressure washer.

Each component is typically comprised of several “parts”, which are the fundamental building blocks of a piece of equipment. Parts cannot be broken into smaller entities. For example, each numbered object within FIG. 2 is a part of the frame component of a specific model of pressure washer.

In the context of IPCs, service technicians use the exploded parts diagrams in parts manuals to identify the parts within a component of a product, and how they go together. For example, the service technician may through physical examination of a pressure washer determine that a piece of the nozzle assembly has been severely dented. By comparing the damaged nozzle assembly to its parts diagram, the technicians can identify the name and supplier identification code for the specific piece or part of the nozzle that needs replacement.

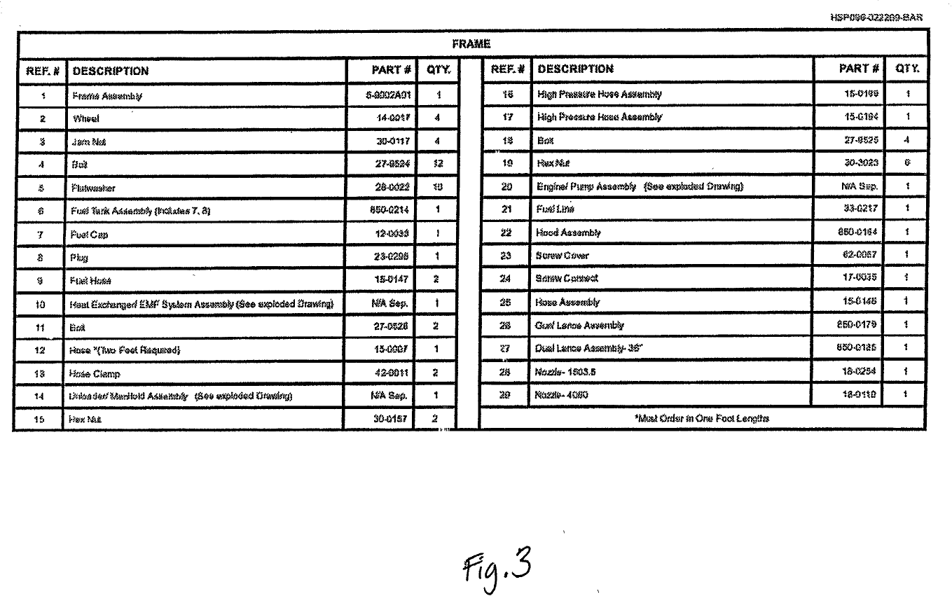

Consider the pressure washer in FIG. 3. Parts 7, 8 and 9 are all separate parts. Part 6 is an “assembly” or grouping of other parts, in this case, parts 7 and 8. Each numbered part, whether an assembly of other parts or a separate part, has a unique entry or record within the parts list associated with the parts diagram. Each entry or record within the parts list describes a part. The set of entries or records within the parts list is, by definition, the set of parts illustrated in that parts diagram. The parts diagram is a graphic representation of the tangible or “real” parts of a product. Each part is graphically represented in the parts diagram, and a graphical representation of a part is called a “graphics element.” In the present invention, each part is represented as a separate graphics element. In the present invention, each graphics element is stored by means of computer code as a separate programming “object”, upon which other computer code may act. To convey this relationship between tangible equipment, graphical representation, and computer code, the computer code that is used to store a graphics element is considered a “Real Object Vector Representation”, or “ROVR”.

Creating ROVRs

While it is relatively easy for a person viewing an exploded parts diagram to identify parts, i.e. graphics elements that represent parts, there is no way for software to automatically differentiate elements. In raster files, there are only pixels. In vector files, graphics elements are not stored as separate “parts”; instead, they are simply independent vector shapes (circles and lines) which, when viewed together by a person, look like parts of a product. There is no connection between the independent vector shapes that would allow software to infer that a part is comprised of certain vector shapes. That is, there is no metadata which says, “these five circles and 12 lines comprise an object that we call a bolt.” The inventive method establishes a separate graphical object (a “ROVR”) for each part, or graphics element, within a parts diagram.

In the inventive method and system, a graphics element is defined by identifying its constituent vector shapes. The vector shapes that make up a graphics element are stored as an independent object, or ROVR. Once graphics elements are identified and separated, the inventive system attaches programming code, typically a script, to the metadata defining each ROVR. This script provides interactivity to the ROVR. For example, the script may cause the ROVR to change color when clicked. The scripted interactivity can include any type of dynamic behavior, including movement and 3-D effects. These scripts also allow the ROVRs to be uniquely linked to database records or other applications. It is this linkage that gives the ROVRs intelligence.

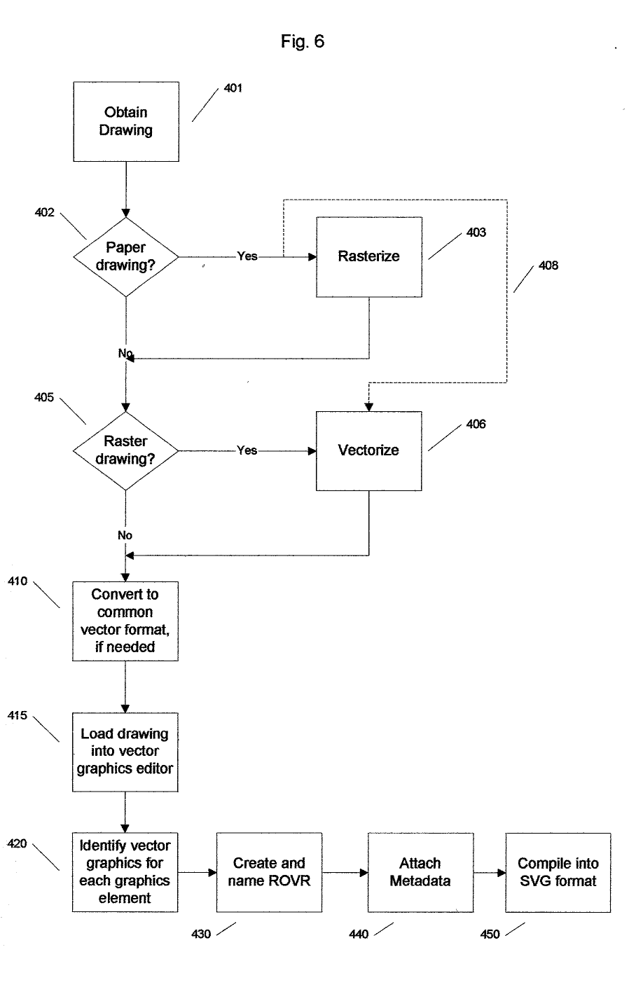

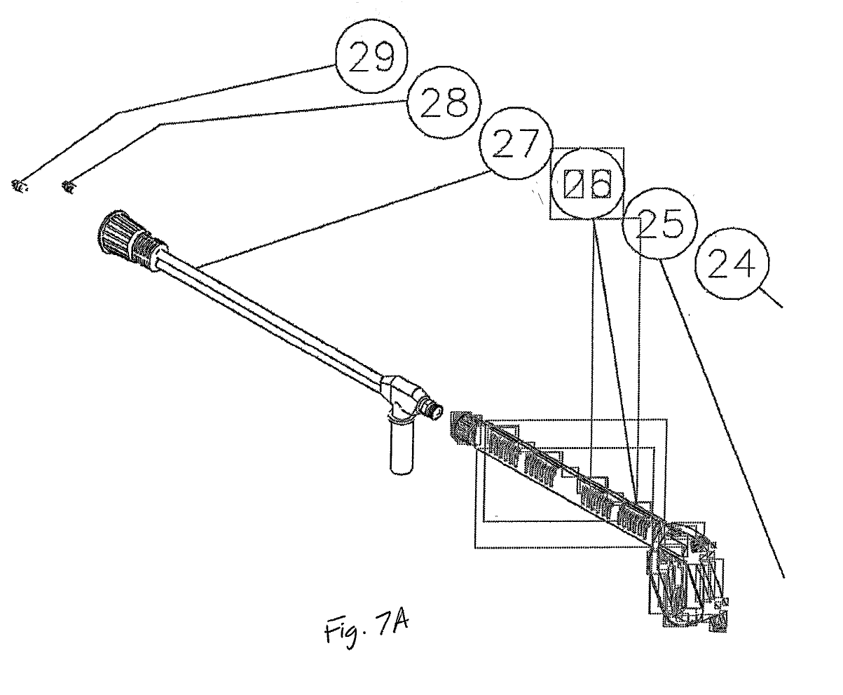

FIG. 6 shows a high level flowchart of the steps involved in building ROVRs in the electronic IPC example in accordance with an embodiment of the invention. First, at step 401, the system obtains graphical drawings that preferably illustrate an exploded parts view. Although the graphical drawings obtained in step 401 are typically CAD files, the drawing may be in other graphic data formats, such as raster. In addition, the present invention is not limited to CAD engineering drawings, other embodiments of the invention may use one or more data formats such as images generated through medical imagery devices. The data may be provided from a variety of different sources. For example, an embodiment of the invention loads the data from one or more data storage locations.

A drawing may be a paper drawing or an electronic file. If the drawing is on paper, in one embodiment the drawing may be converted to a bitmap or raster image as shown by step 403. For example, a paper drawing may be scanned creating an electronic raster image file in a standard format such as TIFF.

As shown by steps 405 and 406, if an electronic drawing is in raster format, whether scanned at step 403 or previously stored as a raster file, it is converted to vector at step 406. If the drawing is in a document format such as PDF, the drawing image is extracted and converted to vector. There are many methods known to those skilled in the art for creating vector drawings from raster images. In one embodiment, a user manually creates a vector file by viewing the electronic raster image and manually creating a vector graphic image using a vector graphics software application. In an alternative embodiment, a user may manually create a vector file by viewing a paper drawing, such that an intermediate raster image is not needed, as shown by alternative logic route 408. In another embodiment, any number of commercially available auto-tracing programs known to those skilled in the art, such as Adobe Streamline and Softcover Scan2CAD may be used to automatically vectorize the raster drawing. In an auto-tracing program, various mathematical algorithms are used to recognize patterns and dots and estimate the most likely graphic vector element that would describe that pattern. For instance, an auto-tracing program may determine that a certain pattern of dots is a circle, and create a circle vector shape.

Even if the drawings obtained at step 401 are already in some type of vector format, they may still need to be converted to a vector format that can more easily be edited, such as DWG, CDR, WMF or FLA, as shown by step 410. For example, a drawing in its native CAD format may be converted through a converter plug-in or through an intermediate graphics editor, such as Adobe Illustrator. At step 415, the vector drawings are loaded into vector graphics editing software, such as Macromedia's Macromedia Flash software. There are many different vector graphics editing software packages available, such as Adobe Illustrator and CorelDraw, which could alternatively be used. Alternatively, custom vector graphics editing software could be developed to use with the method and system of the present invention.

At step 420, the vector graphics that comprise a graphics element are identified and selected. That is, for each part, the lines, circles and other vector graphics that make up a part are identified and selected. This may be done manually, automatically performed by software, or some combination of manual and automated techniques may be used. In a manual environment, a user may use a pen and tablet, or other input device, to select the lines, circles or other vector graphics that comprise a graphics element. The user interface may allow the user to select some and/or all parts of drawings and images or parts thereof, and manipulate the selections. Examples of such interaction are selecting areas, zooming in and out of certain areas, and changing color palettes.

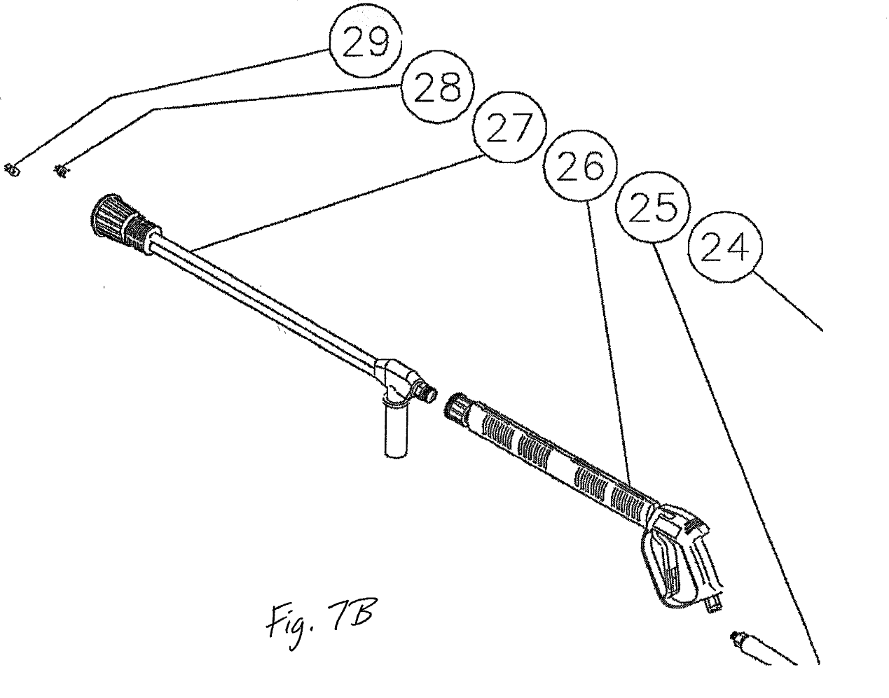

The user interface allows a user to display the drawing and interact with it. FIG. 7A illustrate an example user interface used to perform the graphics element identification and separation for the pressure washer of FIG. 2. As shown, the user selects the vector graphics that comprise graphics element 26 in FIG. 7A. The identified vector graphics are shown highlighted in FIG. 7B.

In an alternative automatic embodiment, a software macro or other application is used to identify the vector graphics that comprise a graphics element through image recognition and feature extracting algorithms. In another alternative embodiment, a combination of automated and manual methods is used. For example, if a user identifies a circle as a vector graphic that is part of a graphics element, a macro or other programming method could be programmed to automatically select all lines and vector graphics contiguous to the circle.

In addition, as shown in FIG. 2, in the electronic IPC example, the identifying number of a graphics element is typically circled, and a line is drawn connecting the circled part number to the graphics element. Therefore, in one embodiment, the user also selects the part identification number, circle and line as part of the graphic element. In an automated embodiment, a macro is used to automatically select the part identification vector graphics as part of the graphics element.

The user interface described above is used to identify the individual vector graphics, such as lines, arcs and polygons that make up a graphics element. The present invention provides a method of storing the selected vector graphics as a single graphics element entity. In one embodiment of the present invention, the identified vector graphics that make up a graphics element are stored as a Macromedia Flash “symbol”. In Macromedia Flash, a “symbol” is a programming object. This is the computer code that stores the information describing the linkage of vector graphics that make up a graphics element. Macromedia Flash symbols provide the means of grouping the vector graphics into meaningful “real objects”. In this embodiment, the Macromedia Flash symbol is the ROVR. As discussed above, a graphics element may be a separate part, or it may be a subassembly comprised of separate parts. If the element being identified and separated is a separate part, the vector graphics, such as lines and circles, are saved as a ROVR. If the element is a subassembly or assembly, the ROVR may be stored such that it points to the ROVRs of the separate parts that comprise the subassembly. For example, in FIG. 2, element 8 may be stored as a relationship symbol that points to the parts that comprise element 8. Alternatively, the subassembly ROVR may duplicate the graphics data of its parts.

Each ROVR is preferably identified by a number or name as shown by step 430. In the IPC example, each ROVR is labeled with its identifying part number in the exploded parts diagram. As will be obvious to one skilled in the art, other methods could be used to identify and name the ROVRs.

Ina manual embodiment, the user creating the ROVR may manually enter this number when identifying graphics elements. Alternatively, in an automated embodiment the system may automatically determine the identifying part number through a software application that recognizes the text inside the selected circle, and automatically names the ROVR by that text or number. This software application could be written as a Microsoft Visual Basic Application, although other programming environments are possible, also.

At step 440, the method and system of the present invention automatically attaches metadata to each ROVR. For example, a programming code, or script, could be attached in the metadata defining each ROVR. This script may provide interactivity to the ROVR. For example, the script may cause the ROVR to change color when the user clicks on it. The scripted interactivity can include any range of dynamic behavior, including movement and 3-D effects. For example, the script may cause the ROVR to change colors upon a mouse rollover. This is different from using hotspots to cause interactive effects. A hotspot is merely a link residing on a layer that is displayed on top of the drawing image. In the present invention, the intelligence is in the ROVR itself. This means that different metadata can be attached to different ROVRs thereby creating different effects. For example, ROVRs of different shapes may be highlighted in different colors, depending on the metadata that is attached to each ROVR.

An example of a script that tells a part that it is an assembly, or collection of separate parts, and that it should activate an interactive effect for those constituent parts when clicked on or rolled over is shown below.

| | |
|---|---|
| 1 | on (release) { |

| | |
|---|---|
| 2 | var subclips = [“4 - Strainer Bowl [9-0103]”, “5 - Stainless Steel |
| | Screen [19-0104]”, “6 - Strainer Gasket [25-0056]”, “7 - Strainer |
| | Body [19-0105]”; |
| 3 | var gotoFrame; |
| 4 | var subGotoFrame; |
| 5 | var i; |
| 6 | if (currentframe == 1) { |

| | |
|---|---|
| 7 | gotoFrame = 2; |
| 8 | subGotoFrame = 3; |

| | |
|---|---|
| 9 | } else if (currentframe == 2) { |

| | |
|---|---|
| 10 | gotoFrame = 1; |
| 11 | subGotoFrame = 1; |

| | |
|---|---|
| 12 | } |
| 13 | for (i=0; i<subclips.length;i++) { |

| | |
|---|---|
| 14 | var subclip=eval(“/” + subclips[l]); |
| 15 | subclip.gotoAndPlay(subGotoFrame); |

| | |
|---|---|
| 16 | } |
| 17 | gotoAndPlay (gotoFrame); |
| 18 | } |

| | |
|---|---|
| 19 | on (rollover) { |

| | |
|---|---|
| 20 | root.partDisplay = name; |

| | |
|---|---|
| 21 | } |

The metadata scripts can be created automatically using a template script. The template script is automatically attached to each ROVR. As each ROVR is created, the template script for that ROVR is generated or customized using information specific to that ROVR. In the example of the above script, a template script is customized using the information that the present ROVR is a subassembly comprised of the parts identified in line 2. There are many methods of creating and using template scripts in Macromedia Flash. For example, templates can be created using the Macromedia Generator template tool. A template can be created using a macro program that records keystrokes and mouseclicks. Template scripts can be manually written. In addition, as will be obvious to those skilled in the art, there are many other methods of automatically creating metadata scripts.

In addition, the scripts may allow the ROVRs to be uniquely linked to external database records or other applications. For example, in the context of electronic IPCs, clicking directly on the different graphics elements or ROVRs can trigger local inventory searches, pricing and availability queries, and replacement orders directly from linked ERP systems. In the method and system of the present invention, each individual part within a parts diagram can be linked to external databases, as each individual part is stored as a ROVR. For example, upon a mouse rollover, a ROVR can be scripted to light up, obtain current pricing information for that part, and Macromedia Flash that information on the screen of the viewing application. This is all done on a standard web browser, as web browsers recognize SVG files. This is a substantial improvement upon current electronic IPC systems, where at best, an entire drawing may be linked to an external system. No other system provides the ability to link individual parts to external applications and databases in such a ubiquitous, powerful, and easy to use fashion.

While the above example describes a method of implementing thee present invention using Macromedia Flash objects, it will be obvious to one skilled in the art that ROVRs can be created and stored using other applications. Any application that can group individual vector graphics into a single entity that intelligently represents a graphics element using an embedded script, program or macro can be used.

The ROVR is then stored in a standard scalable vector graphics format, such as SVG or SWF. For example, if the ROVR is created using Macromedia Flash, the Macromedia Flash metadata script is compiled into SWF or SVG using standard Macromedia Flash functions.

The scalable vector graphics format file created using the method and system of the present invention is comparatively small. Therefore, unlike other current systems, it is possible to use the files created using the inventive method and system on mobile devices, such as handheld computers. This is an important advantage over current systems. In the context of IPCs, a service technician can access and view information about the parts in a parts diagram on a mobile device in near real-time even though all of the information is remote.

The inventive system allows for extremely small graphics files that unlike raster images, can be easily and accurately zoomed and manipulated, but unlike most vector graphics files, can also be viewed on a standard browser. In addition, the graphics files created using the inventive system contain intelligence about the individual parts they represent.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the present invention.

What is claimed:

1. In a computer system, a method of representing a plurality of entities within a drawing as real object vector representations, comprising the steps of:
(a) obtaining a drawing;
(b) for each entity in the drawing, identifying at least one vector graphic within the drawing;
(c) creating a computer-storable object that is comprised of the identified at least one vector graphic; and
(d) attaching metadata to the computer-storable object.

2. The method of claim 1, wherein the drawing is a raster image and step (a) additionally comprises the step of:
(i) converting the raster image into a vector-based image.

3. The method of claim 2, wherein-step (a)(i) comprises creating a vector-based image corresponding to the raster image using a vector graphics editor.

4. The method of claim 2, wherein the drawing is a raster image and step (a)(i) comprises creating a vector-based image corresponding to the raster image through an auto-tracing application.

5. The method of claim 1, wherein the drawing is a paper drawing, and step (a) comprises:
(i) scanning the drawing creating a raster image; and
(ii) converting the raster image into a vector-based image.

6. The method of claim 5, wherein step (a)(ii) comprises creating a vector-based image corresponding to the raster image using a vector graphics editor.

7. The method of claim 5, wherein the drawing is a raster image and step (a)(ii) comprises creating a vector-based image corresponding to the raster image through an auto-tracing application.

8. The method of claim 1, wherein the drawing is a CAD format file and step (a) additionally comprises the step of converting the CAD format file into a format that can be viewed in a graphics editor.

9. The method of claim 8, wherein the format that can be viewed in a graphics editor is selected from the group consisting of DWG, CDR, WMF and FLA.

10. The method of claim 1, wherein step (b) comprises selecting at least one graphic vector in an application.

11. The method of claim 10, a user using the application selects individual graphic vectors using a pen and tablet interface.

12. The method of claim 10, wherein the application automatically selects graphic vectors upon a user selecting contiguous graphic vectors.

13. The method of claim 1, wherein the computer-storable object is a Macromedia Flash symbol.

14. The method of claim 1, wherein step (d) comprises generating at least one script and attaching the at least one script to the computer-storable object.

15. The method of claim 14, wherein said at least one script causes the computer-storable object to highlight vector graphics when viewed in a viewing application upon a predetermined event.

16. The method of claim 15, wherein said predetermined event is selected from the group consisting of a mouse click on the object in the viewing application and a mouse rollover on the object in the viewing application.

17. The method of claim 14, wherein said at least one script causes the computer-storable object to link to an external database or application upon a predetermined event.

18. The method of claim 17, wherein said predetermined event is selected from the group consisting of a mouse click on the object in the viewing application and a mouse rollover on the object in the viewing application.

19. The method of claim 1, wherein said computer-storable object is stored in a scalable vector graphics format file.

20. The method of claim 19, wherein said scalable vector graphics format is selected from the group consisting of SVG and SWF.

21. A method of embedding intelligence in every part in a vector-based parts diagram, comprising the steps of:
(a) creating a template script;
(b) for each part, identifying at least one vector graphic in the parts diagram;
(c) for each part, customizing the template script using information specific to that part; and
(d) for each part, storing the customized script with computer code defining the part.

22. The method of claim 21, wherein the computer code defining each part is a Macromedia Flash symbol, and the template script is a Macromedia Flash script.

23. The method of claim 21, wherein the template script contains interactive effects commands and external link commands.

24. A system for embedding intelligence in every part in a vector-based parts diagram, comprising:
(a) a template script;
(b) for each part, means for identifying at least one vector graphic in the parts diagram;
(c) for each part, means for customizing the template script using information specific to that part; and
(d) for each part, means for storing the customized script with computer code defining the part.

25. The system of claim 24, wherein the computer code defining each part is a Macromedia Flash symbol, and the template script is a Macromedia Flash script.

26. The system of claim 24, wherein the template script contains interactive effects commands and external link commands.

27. A method of viewing a parts diagram in a web browser, wherein every part in the parts diagram is stored as a separate object, and every part is linked to information stored in an external application that is specific to that part, such that a predefined event will cause information specific to that part to be displayed with the part in the web browser.

28. The method of claim 27, wherein each part is stored in an SVG format file.

29. The method of claim 27, wherein said part-specific information is selected from the group consisting of price, availability and location.

30. A method of viewing a parts diagram in an application on a mobile device, wherein every part in the parts diagram is stored as a separate object, and every part is linked to information stored in at least one external application that is specific to that part, such that a predefined user interaction event will cause information specific to that part to be displayed with the part in the mobile device application.

31. The method of claim 30, wherein each part is stored in an SVG format file.

32. The method of claim 30, wherein said part-specific information is selected from the group consisting of price, availability, and location.

33. The method of claim 30, wherein said mobile device is selected from the group consisting of a handheld computer, a pocket computer and a personal data assistant.
